(19) United States
(12) Patent Application Publication
(10) Pub. No.: US 2015/0360455 A1
(43) Pub. Date: Dec. 17, 2015

(54) APPLYING METHOD, APPLYING DEVICE, MANUFACTURING METHOD, AND MANUFACTURING DEVICE

(71) Applicants: HIRATA CORPORATION, Tokyo (JP); DEXERIALS CORPORATION, Tokyo (JP)

(72) Inventors: Itsuo FUJIWARA, Tokyo (JP); Tokuo TAKAMOTO, Tokyo (JP); Yoshihisa NAGATA, Tokyo (JP); Yushi NAKAGAWA, Tokyo (JP); Kazuomi HAYANO, Tokyo (JP); Koichi OGAWA, Tokyo (JP)

(73) Assignees: HIRATA CORPORATION, Tokyo (JP); DEXERIALS CORPORATION, Tokyo (JP)

(21) Appl. No.: 14/739,066

(22) Filed: Jun. 15, 2015

(30) Foreign Application Priority Data
Jun. 16, 2014 (JP) 2014-123794

(51) Int. Cl. B32B 37/10; B05B 12/08; B05D 1/02

(52) U.S. Cl. CPC B32B 37/10; B05D 1/02; B05B 12/084; B32B 2305/72

(57) ABSTRACT

The present invention provides a method of applying a photocurable resin on a surface of a panel. A difference in a surface level is formed on a peripheral portion on the surface of the panel. The method includes a step of moving either one of an application head and the panel so that the application head provided with a slit-type nozzle which discharges a photocurable resin relatively moves on the surface of the panel, and an application step of discharging the resin from the nozzle onto the surface of the panel during the moving step. In the application process, a film thickness of the resin is controlled so that a difference in a surface level is not generated on a liquid film surface of the resin on the difference in a surface level on the panel.

### BACKGROUND OF THE INVENTION

1. Field of the Invention

The present invention relates mainly to a technology of applying a liquid photocurable resin on a panel.

2. Description of the Related Art

Displays in which an image display panel such as a liquid crystal display panel and a cover panel are bonded by adhesion such as displays for TV, personal computers, portable terminals and the like are known (see Japanese Patent No. 5138820, for example). A photocurable resin is known to be used as an adhesive for bonding these panels together. The photocurable resin is applied on a surface of the cover panel, for example, which is bonded to the image display panel. After that, the photocurable resin is irradiated with ultraviolet rays so as to cure the photocurable resin.

The surface of the panel on which the photocurable resin is to be applied has a difference in a surface level in some cases. In the case of the above-described cover panel, for example, a light shielding layer is formed on a surface peripheral edge of a panel body, and a difference in a surface level is generated on a boundary between a portion with the light shielding layer and a portion without it. When a liquid film of the photocurable resin is applied on the surface of the cover panel, a difference in a surface level is generated also on a liquid film surface on this stepped portion in some cases. If the image display panel is bonded in a state with the difference in a surface level in the liquid film, it can cause mixing of air bubbles and separation. Thus, cancellation of the difference in a surface level on the liquid film surface by applying the photocurable resin thicker than the thickness of the light shielding layer is proposed (see Japanese Patent No. 5138820, Japanese Patent No. 5218802, Japanese Patent Laid-Open No. 2013-156641, for example).

However, only by applying the photocurable resin thicker than the thickness of the light shielding layer, the difference in a surface level on the liquid film surface might remain.

### SUMMARY OF THE INVENTION

The present invention has an object to reduce generation of a difference in a surface level on a liquid film surface caused by a difference in a surface level on a panel surface.

According to one aspect of the present invention, there is provided an applying method of applying a liquid photocurable resin on a surface of a panel, a difference in a surface level being formed on a peripheral portion of the surface of the panel, the applying method including: a moving step of moving either one of an application head or the panel so that the application head provided with a slit-type nozzle capable of discharging a photocurable resin relatively moves on the surface of the panel; and an application step of discharging the photocurable resin from the nozzle onto the surface of the panel during the moving step, wherein in the application step, a film thickness of the photocurable resin is controlled so that a difference in a surface level is not generated on a liquid film surface of the photocurable resin on the difference in a surface level on the panel.

According to another aspect of the present invention, there is provided an applying device for applying a liquid photocurable resin on a surface of a panel, comprising: an application head provided with a slit-type nozzle capable of discharging the photocurable resin; a moving mechanism configured to move at least either one of the application head or the panel so that the application head relatively moves on the surface of the panel; and a control unit configured to control the application head and the moving mechanism, wherein a difference in a surface level is formed on a peripheral portion of the surface of the panel; and the control unit executes: movement control for moving at least either one of the application head or the panel by the moving mechanism; and application control for discharging the photocurable resin from the nozzle to the surface of the panel during the movement control; and in the application control, on a difference in a surface level on the panel, a film thickness of the photocurable resin is controlled so that a difference in a surface level is not generated on a liquid film surface of the photocurable resin.

According to still another aspect of the present invention, a manufacturing method using the above-described applying method and a manufacturing device using the above-described applying device are provided.

Further features of the present invention will become apparent from the following description of exemplary embodiments (with reference to the attached drawings).

### BRIEF DESCRIPTION OF THE DRAWINGS

FIG. 1 is a plan view of a manufacturing device according to an embodiment of the present invention;

FIG. 2 is an arrow view in an arrow D1 direction in FIG. 1 of the manufacturing device in FIG. 1;

FIG. 3 is an arrow view in an arrow D2 direction in FIG. 1 of the manufacturing device in FIG. 1;

FIG. 4A is an arrow view in an arrow D3 direction in FIG. 2 of the manufacturing device in FIG. 1, and FIG. 4B is an explanatory view of a laminated body;

FIG. 5 is a block diagram of a control unit;

FIGS. 6A to 6C are operation explanatory views of the manufacturing device of FIG. 1;

FIGS. 7A to 7C are operation explanatory views of the manufacturing device of FIG. 1;

FIGS. 8A and 8B are operation explanatory views of the manufacturing device of FIG. 1;

FIGS. 9A and 9B are operation explanatory views of the manufacturing device of FIG. 1;

FIG. 10A is an explanatory view of a step on a panel surface, FIG. 10B is an explanatory view of a difference in a surface level on a liquid film surface, and FIGS. 100 to 10E are views illustrating control examples of a film thickness;

FIGS. 11A to 11D are operation explanatory views of the manufacturing device of FIG. 1;

FIGS. 12A to 12C are operation explanatory views of the manufacturing device of FIG. 1;

FIG. 13 is an operation explanatory view of the manufacturing device of FIG. 1;

FIGS. 14A to 14C are operation explanatory views of the manufacturing device of FIG. 1;

FIGS. 15A to 15C are operation explanatory views of the manufacturing device of FIG. 1;

FIG. 16 is an operation explanatory view of the manufacturing device of FIG. 1;

FIG. 17 is a plan view of a manufacturing device of another example; and

FIG. 18 is a plan view of a manufacturing device of another example.

### DESCRIPTION OF THE EMBODIMENTS

Embodiments of the present invention will be described below by referring to the attached drawings. In each figure, arrows X and Y indicate horizontal directions orthogonal to each other and an arrow Z indicates a vertical direction.

### First Embodiment

### Outline of Device

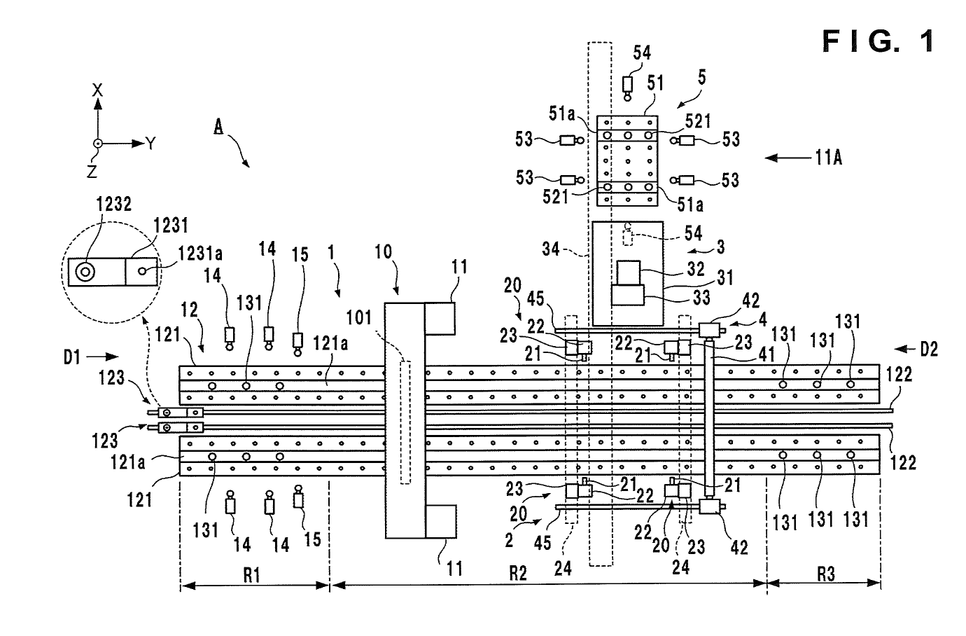

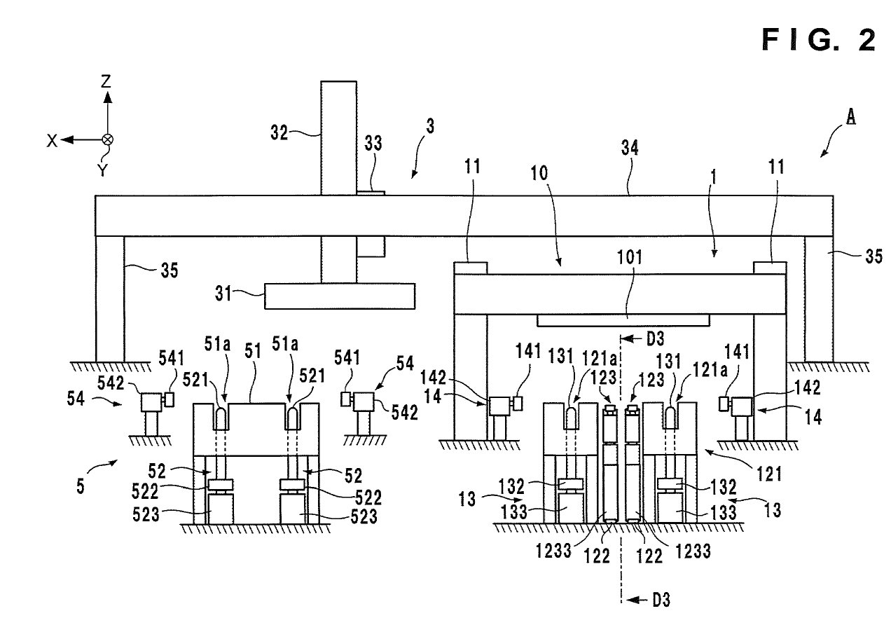

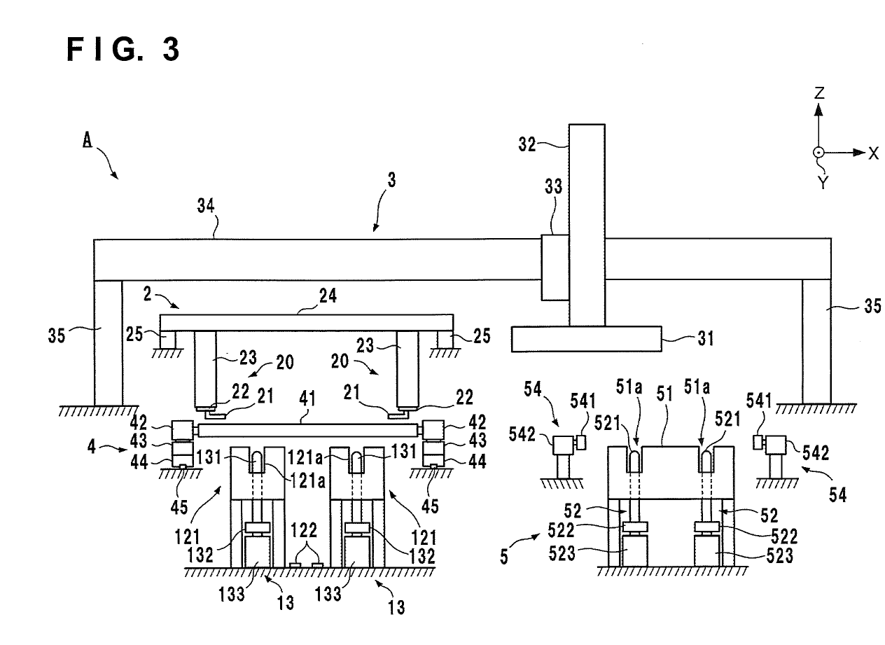

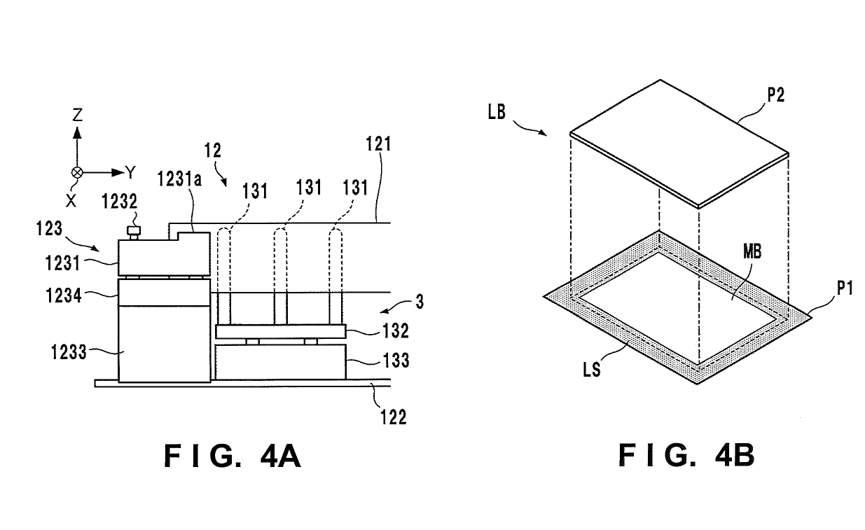

FIG. 1 is a plan view of a manufacturing device A according to an embodiment of the present invention, FIG. 2 is an arrow view in an arrow D1 direction in FIG. 1 of the manufacturing device A, FIG. 3 is an arrow view in an arrow D2 direction in FIG. 1 of the manufacturing device A, and FIG. 4A is an arrow view in an arrow D3 direction in FIG. 2 of the manufacturing device A. FIG. 4B is an exploded perspective view of a laminated body to be manufactured.

The manufacturing device A is a device for manufacturing a laminated body of two panels. In this embodiment, as illustrated in FIG. 4B, a laminated body LB of a rectangular panel P1 and a rectangular panel P2 is manufactured. The panel P1 is a cover panel, the panel P2 is an image display panel, and their laminated body LB constitutes an image display device. The panel P2 which is the image display panel is a liquid crystal display panel (LCD, for example), for example, and to its display surface side (a lower surface in FIG. 4B), the panel P1 which is the cover panel (cover glass, for example) is bonded. The panel P1 includes a light transmissive panel body MB. The panel body MB is a glass plate or a resin plate, for example. A light shielding layer LS is formed on a peripheral edge of a surface of the panel body MB (an upper surface in FIG. 4B) to which the panel P2 is bonded.

The manufacturing device A includes a carrying-in area R1, a processing area R2, and a carrying-out area R3 in a layout of the device. In the carrying-in area R1, the panel P1 is delivered from a device of a supply source of the panel P1, and the panel P1 is carried in. In the processing area R2, application of a photocurable resin on the panel P1 and bonding to the panel P2 are performed. In the carrying-out area R3, the laminated body LB of the two panels P1 and P2 bonded in the processing area R2 is delivered to a device of a supply destination, and the laminated body LB is carried out.

The manufacturing device A includes an applying device 1, a holding unit 2, a laminating unit 3, a pressing unit 4, and a carrying-in table 5.

<Applying Device>

The applying device 1 is a device for applying a liquid photocurable resin on a surface of the panel P1 and includes an application head 10, and moving mechanisms 11 and 12. First, a configuration of the moving mechanism 12 will be described.

The moving mechanism 12 is a mechanism for moving the panel P1 in a horizontal attitude to a Y-direction and also serves as a panel conveying mechanism of the entire manufacturing device A. The moving mechanism 12 includes a plurality of air floating tables 121, a plurality of slide units 123, and rails 122 provided at each of the slide units 123 in this embodiment.

The air floating table 121 includes a horizontal upper surface in which a large number of air holes are formed. The air holes communicate with an air device, not shown, through a passage inside the air floating table 121. The air device is an air supply device or an air suction device represented by a pump. By injecting air from the air hole, the panel P1 can be supported in a floated state. Moreover, by injecting air from a part of the air holes and by suctioning air from the other part of the air holes so as to cause a part of the air floating table 121 to act as a Bernoulli chuck, the panel P1 can be supported stably and in a precise floated state.

The air floating table 121 is extended in the Y-direction which is a conveying direction of the panel P1. In more detail, it is extended from the carrying-in area R1 to the carrying-out area R3. Therefore, the panel P1 and the laminated body LB can be supported in a non-contact manner on an entire region of the manufacturing device A. The air floating tables 121 are provided in two, and they are extended in parallel with each other and are arranged away from each other in an X-direction. A gap in the X-direction between the two air floating tables 121 forms a movement space of the plurality of slide units 123. A groove 121a is formed in an upper surface of the air floating table 121. The groove 121a is a retreat space of a pin 131 of an elevating unit 13 which will be described later.

The slide unit 123 conveys the panel P1 supported on the air floating table 121 in the floating state from the carrying-in area R1 to the carrying-out area R3. The slide unit 123 is capable of reciprocating movement in the Y-direction by a driving mechanism, not shown, by being guided by the rails 122 extended in the Y-direction. A ball screw mechanism, a belt transmission mechanism and the like, for example, can be employed for the driving mechanism. The slide units 123 are provided in two. By providing the driving mechanism for each of the slide units 123 so as to allow independent movement, start of conveyance of a subsequent panel in the middle of the conveyance of one panel, that is, conveyance of two panels located at separate areas at separate timing is made possible.

The slide unit 123 includes a suctioning portion 1231, a contact portion 1232, a slider 1233, and an elevating mechanism 1234. The suctioning portion 1231 is provided with an upper surface in which a suction hole 1231a is formed. This upper surface constitutes a horizontal suction surface capable of being sucked by a lower surface of the panel P1. The suction hole 1231a communicates with an air device, not shown, through a passage inside the suctioning portion 1231. The air device is an air suction device represented by a pump. The panel P1 can be sucked/held by suctioning air from the suction hole 1231a.

The contact portion 1232 can be brought into contact with an end edge of the panel P1. In this embodiment, the contact portion 1232 is a roller provided on an upper part of the suctioning portion 1231 rotatably through a support shaft. The contact portion 1232 is brought into contact with the end edge of the panel P1 (end edge on an upstream side) mainly when an attitude of the panel P1 is adjusted during carrying-in of the panel. A position of the suction surface of the suctioning portion 1231 in the Z-direction is set within a range from a lower end to an upper end of the contact portion 1232 in the Z-direction. Thus, the suction surface of the suctioning portion 1231 is located at a position higher by one step than a portion on which the support shaft of the contact portion 1232 is stood.

The slider 1233 is engaged with the rail 122 and can be moved in the Y-direction by being guided by the rail 122. The elevating mechanism 1234 is mounted on the slider 1233. The elevating mechanism 1234 includes an actuator such as an air cylinder, an electric cylinder, an electromagnetic solenoid and the like, for example, as its driving source. The suctioning portion 1231 is mounted on the elevating mechanism 1234 and is elevated up/down by the elevating mechanism 1234. The suctioning portion 1231 is elevated up/down between a suction position where the suction surface is located above the upper surface of the air floating table 121 and a retreat position where the entire suctioning portion 1231 is located below the upper surface of the air floating table 121. The suction position is a position where the suctioning portion 1231 is suctioned/held by the panel P1, and the suctioning portion 1231 is located slightly above the upper surface of the air floating table 121.

Next, the application head 10 and the moving mechanism 11 will be described. The application head 10 is arranged above the air floating table 121 in the processing area R2 and is provided with a nozzle 101 arranged so as to face the upper surface of the air floating table 121. The nozzle 101 can discharge the liquid photocurable resin having light transmitting property.

The nozzle 101 is a slit-type nozzle extending in the X-direction, and the photocurable resin is continuously discharged downward in a curtain state spread in the X-direction. By discharging the photocurable resin while the panel is being conveyed, a liquid film of the photocurable resin can be formed on the surface of the panel P1.

The moving mechanisms 11 are provided on both end portions of the application head 10 in the X-direction, respectively, and support the application head 10 in the horizontal attitude. Each of the moving mechanisms 11 is provided with a driving mechanism, not shown, and is controlled synchronously with each other and moves the application head 10 in the Z-direction. In other words, the moving mechanism 11 is elevated up/down while holding the application head 10 in the horizontal attitude. The application head 10 cannot move in the Y-direction and the X-direction. A ball screw mechanism, a belt transmission mechanism or the like, for example, can be employed for the driving mechanism.

Next, a constitution around the applying device 1 will be described. The elevating unit 13 and the adjustment units 14 and 15 are provided in the carrying-in area R1.

The elevating unit 13 is a unit for delivering the panel P1 between an external device and the manufacturing device A. Two elevating units 13 are provided in the carrying-in area R1, and two elevating units 13 are also provided in the carrying-out area R3, respectively. Here, the laminated body LB is delivered between the external device and the manufacturing device A.

The elevating unit 13 includes a plurality of the pins 131, a support member 132, and an elevating mechanism 133. The plurality of pins 131 are supported by the support member 132 and extend in an upward direction. Each of the pins 131 is inserted into a vertical through hole provided in the groove 121a of the air floating table 121. The plurality of pins 131 have the equal lengths, and heights of their tip ends (upper ends) are flush.

The support member 132 is located below the air floating table 121 and to which lower ends of the pins 131 are fixed. The elevating mechanism 133 includes an actuator such as an air cylinder, an electric cylinder, an electromagnetic solenoid or the like, for example, as its driving source and elevates up/down the support member 132. The pin 131 is also elevated up/down by elevating up/down the support member 132. The pin 131 is elevated up/down between a raised position where its tip end protrudes upward from the upper surface of the air floating table 121 and a lowered position where the tip end of the pin 131 is located below the upper surface 10 of the air floating table 121. FIGS. 2, 3, and 4A illustrate a case in which the pins 131 are at the lowered positions, and the tip end of the pins 131 are located in the grooves 121a.

The adjustment units 14 and 15 perform positioning by adjusting an attitude of the panel P1 in the carrying-in area R1. The adjustment unit 14 adjusts the attitude of the panel P1 in the X-direction, while the adjustment unit 15 adjusts the attitude of the panel P1 in the Y-direction.

The adjustment units 14 are provided in plural in the carrying-in area R1 and are arranged on both sides in the X-direction by sandwiching the two air floating tables 121. The adjustment unit 14 includes a columnar contact unit 141 and a driving unit 142. The driving unit 142 includes an actuator such as an air cylinder, an electric cylinder, an electromagnetic solenoid or the like, for example, as its driving source and reciprocates the contact unit 141 in the X-direction. The contact unit 141 is movable from a retreat position spaced away from the air floating table 121 to a positioning position closer to the air floating table 121 by driving of the driving unit 142. At the positioning position, the contact unit 141 is capable of attitude adjustment and positioning in contact with an end edge of the panel in the X-direction. The adjustment unit 15 also has a configuration similar to that of the adjustment unit 14 and its contact unit is in contact with the end edge (downstream-side end edge) of the panel P1 in the Y-direction and is capable of attitude adjustment and positioning thereof.

<Holding Unit>

Next, the holding unit 2 will be described. The holding unit 2 is a unit for holding the panel P1 on one surface of which the photocurable resin is applied by the applying device 1. The panel P2 is laminated in a state in which the panel P1 is held by the holding unit 2.

The holding unit 2 includes a plurality of holding mechanisms 20 and a plurality of support members 24 and 25. The holding mechanisms 20 are provided in four, and two of them are arranged away from each other in the Y-direction on one side of the two air floating tables 121 in the X-direction. The remaining two are arranged away from each other in the Y-direction on the other side of the two air floating tables 121 in the X-direction.

The holding mechanism 20 includes a holding portion 21, a supporting unit 22, and an elevating mechanism 23. The holding portion 21 is a claw-shaped member arranged so as to be brought into contact with a lower surface of a corner part of the panel P1. The supporting unit 22 is a member for supporting the holding portion 21. The elevating mechanism 23 includes an actuator such as an air cylinder, an electric cylinder, an electromagnetic solenoid or the like, for example, as its driving source and is a mechanism for elevating up/down the supporting unit 22. The holding portion 21 is also elevated up/down by elevating up/down the supporting unit 22. The holding portion 21 of each of the holding mechanisms 20 is located at the same height, and their elevating operation is performed synchronously.

The support member 24 is a beam member for supporting the holding mechanisms 20, and the two holding mechanisms 20 are supported by the one support member 24 so as to be suspended. The support members 25 are provided on both end portions of the support member 24 and each of them is a column member for supporting the support member 24 in the horizontal attitude.

<Laminating Unit>

The laminating unit 3 is a mechanism for conveying the panel P2 having been carried onto a carrying-in table 5 to above the panel P1 held by the holding unit 2 and for lowering and laminating it. The laminating unit 3 includes a suctioning unit 31, a support member 32, a movable unit 33, a rail member 34, and a plurality of columns 35.

The suctioning unit 31 has its lower surface constituting a horizontal suction surface. An air hole is formed in this suction surface and is connected to an air suction device, not shown, through a passage inside the suctioning unit 31. The air suction device is a pump, for example. The suctioning unit 31 suctions the upper surface of the panel P2 with negative-pressure suctioning by suctioning air through the air hole.

The support member 32 is an elevation shaft extending in the Z-direction to be elevated up/down by the movable unit 33, and the suctioning unit 31 is fixed to a lower end of the support member 32. The movable unit 33 includes an elevating mechanism for elevating up/down the support member 32. A ball screw mechanism, a belt transmission mechanism or the like, for example, can be employed for the elevating mechanism. The rail member 34 is extended horizontally in the X-direction and both end portions thereof are supported by the column 35. The movable unit 33 is capable of reciprocating in the X-direction by being guided by the rail member 34 by a driving mechanism, not shown. A ball screw mechanism, a belt transmission mechanism or the like, for example, can be employed for the driving mechanism. The suctioning unit 31 is movable on an X-Z plane by movement in the X-direction of the movable unit 33 and elevation of the support member 32.

<Pressing Unit>

The pressing unit 4 is a mechanism for applying a pressing force to the laminated body LB of the panel P1 and the panel P2 horizontally held and laminated on each of the holding portion 21 of the holding unit 2 in its thickness direction (Z-direction, here). The panel P1 and the panel P2 may be laminated in contact with each other or may be laminated by being slightly spaced away from each other. The pressing unit 4 includes a roller 41, a plurality of supporting units 42, a plurality of elevating mechanisms 43, a plurality of sliders 44, and a plurality of rails 45. The supporting units 42, the elevating mechanisms 43, the sliders 44, and the rails 45 are provided in two sets, and the elevating mechanism 43 is mounted on the slider 44, and the supporting unit 42 is mounted on the elevating mechanism 43.

The roller 41 is extended horizontally in the X-direction so as to go across the two air floating tables 121. The roller 41 is a free roller supported rotatably on both end portions thereof by the supporting units 42 and capable of free rotation. The rail 45 is arranged on both sides, respectively, by sandwiching the two floating tables 121 and is extended horizontally in the Y-direction. The slider 44 is engaged with the rail 45 and is movable in the Y-direction by being guided by the rail 45. The slider 44 is capable of reciprocating in the Y-direction by a driving mechanism, not shown. The roller 41 can be moved parallelly in the Y-direction by moving the two sliders 44 synchronously.

The elevating mechanism 43 includes an actuator such as an air cylinder, an electric cylinder, an electromagnetic solenoid or the like, for example, as its driving source and elevates the supporting units 42 up/down. The roller 41 can be moved parallel (elevated up/down) in the Z-direction by elevating/moving the two supporting units 42 synchronously.

<Carrying-In Table>

The carrying-in table 5 is a unit for delivering the panel P2 between the external device and the manufacturing device A. The carrying-in table 5 includes an air floating table 51 and an elevating unit 52. The air floating table 51 has a configuration similar to that of the air floating table 121 and is provided with a horizontal upper surface in which a large number of air holes are formed. The air floating table 51 can support the panel P2 in a floating state by injecting air from the air holes.

The elevating unit 52 has a configuration similar to that of the elevating unit 13 and includes a plurality of pins 521, a support member 522, and an elevating mechanism 523. The plurality of pins 521 are supported by a support member 522 and extend in an upward direction. Each of the pins 521 is inserted into a vertical through hole provided in a groove 51a of the air floating table 51. The plurality of pins 521 have the equal lengths, and heights of their tip ends (upper ends) are flush.

The support member 522 is located below the air floating table 51 and to which lower ends of the pins 521 are fixed. The elevating mechanism 523 includes an actuator such as an air cylinder, an electric cylinder, an electromagnetic solenoid or the like, for example, as its driving source and elevates up/down the support member 522. The pin 521 is also elevated up/down by elevation of the support member 522. The pin 521 is elevated up/down between a raised position where its tip end protrudes upward from the upper surface 10 of the air floating table 51 and a lowered position where the tip end of the pin 521 is located below the upper surface of the air floating table 51.

Adjustment units 53 and 54 are disposed around the air floating table 51. The adjustment units 53 and 54 adjust the attitude of the panel P2 on the air floating table 51 and position it. The adjustment unit 53 adjusts the attitude of the panel P2 in the Y-direction, and the adjustment unit 54 adjusts the attitude of the panel P2 in the X-direction. The adjustment units 53 and 54 have configurations similar to that of the adjustment unit 14 or 15, and principles of the attitude adjustment and positioning are also similar.

<Control Unit>

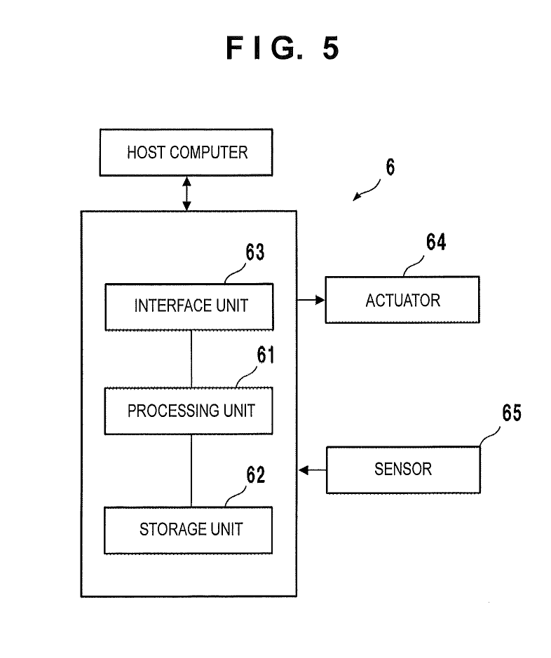

FIG. 5 is a block diagram of a control unit 6 executing control of the manufacturing device A. The control unit 6 includes a processing unit 61 such as a CPU or the like, a storage unit 62 such as a RAM, a ROM or the like, and an interface unit 63 allowing an external device to interface with the processing unit 61. The interface unit 63 also includes a communication interface conducting communication with a host computer. The host computer is a computer which controls entire manufacturing facilities in which the manufacturing device A is arranged, for example.

The processing unit 61 executes a program stored in the storage unit 62 and controls various actuators 64 on the basis of detection results of various sensors 65 and instructions of superior computers and the like. The various sensors 65 include various sensors such as a sensor for detecting a position of the slide unit 123, a sensor for detecting a position of the application head 10, a sensor for detecting a position of the supporting unit 42, a sensor for detecting a position of the suctioning unit 31, and the like. Various actuators 93 include the air device for the air floating tables 121 and 51, the air device for the suctioning portion 1231, the air device for the suctioning unit 21, the driving source of the application head 10, the driving sources of the various mechanisms and the like, for example.

<Control Example>

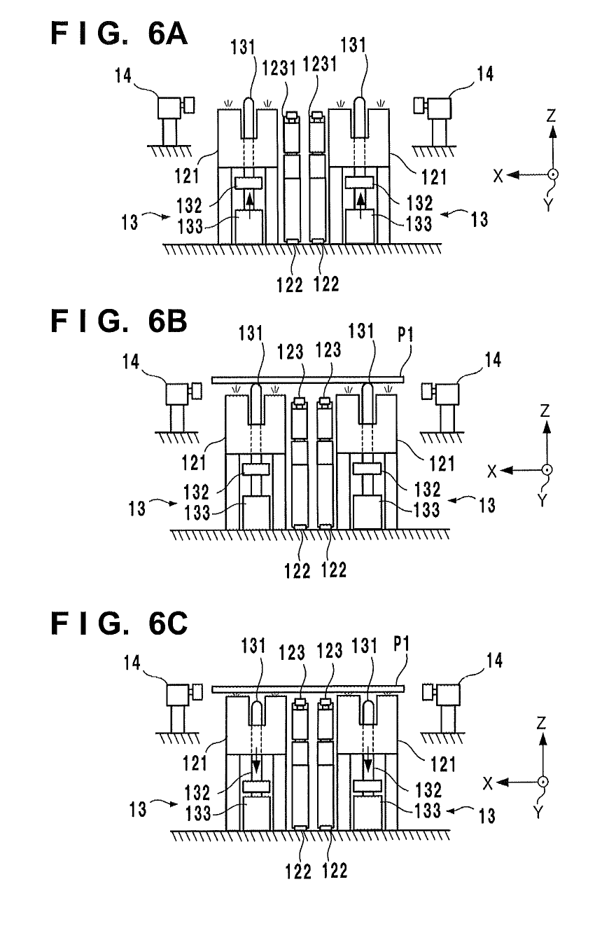

A control example of the processing unit 61 will be described by referring to FIGS. 6A to 16. Here, a series of operations including carrying-in of the panels P1 and P2 to the manufacturing device A, conveying to the panel P1, application of the photocurable resin to the panel P1, bonding of the panel P1 and the panel P2 together, and carrying-out of the laminated body LB will be described.

FIG. 6A illustrates a state immediately before the panel P1 is carried in the carrying-in area R1 by the external device. In the two elevating units 13 provided in the carrying-in area R1, each pin 131 is located at the raised position. The suctioning portion 1231 is located at the retreat position at a position on an upstream end (referred to as an initial position) of the carrying-in area R1. The contact unit 141 of the adjustment unit 14 is located at the retreat position. The same applies to the adjustment unit 15, not shown. Air is injected from an air hole 12 of the air floating table 121.

FIG. 6B illustrates a state in which the panel P1 has been carried into the carrying-in area R1 by the external device. The panel P1 is placed on the plurality of pins 131 in the horizontal attitude with a surface on which the light shielding layer LS is formed as an upper surface. After that, the two elevating units 13 provided in the carrying-in area R1 as illustrated in FIG. 6C lower each pin 131 to the lowered position. As a result, the panel P1 is transferred to the air floating table 121 from the plurality of pins 131. At this time, the panel P2 is not in close contact with the upper surface of the air floating table 121 but is supported in a floating state slightly floating from the upper surface.

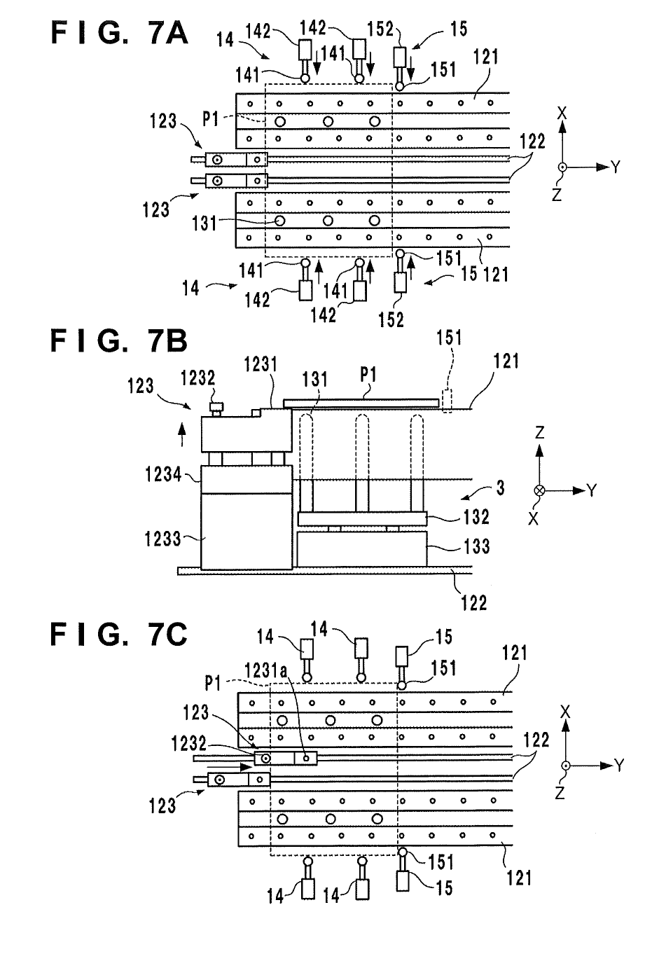

Next, the attitude adjustment and positioning of the panel P1 are performed. As illustrated in FIG. 7A, each of the adjustment units 14 is driven, and the contact unit 141 is moved to the positioning position. A separation distance in the X-direction between the contact units 141 at the positioning position is substantially equal to the width of the panel P1 in the X-direction. Thus, if the attitude of the panel P1 is disturbed, the contact unit 141 is brought into contact with a side edge of the panel P1, and the attitude and the position are adjusted. As a result, a pair of sides located on both sides in the Y-direction and opposed to each other among four sides of the panel P1 become parallel with the X-direction (extended direction of the nozzle 101). Moreover, the remaining pair of sides located on both sides in the X-direction becomes parallel with the Y-direction.

At the same time, positioning of the panel P1 in the Y-direction to the slide unit 123 is performed. In the adjustment unit 15, its contact unit 151 moves to the positioning position by driving of the driving unit 152. One of the two slide units 123 is used for movement of the panel P1. As illustrated in FIG. 7B, the suctioning portion 1231 is raised to the suction position by the elevating mechanism 1234.

As illustrated in FIG. 7C, the slide unit 123 is moved in the Y-direction only by a distance set in accordance with a size of the panel P1 and stopped. At this time, the contact portion 1232 of the suctioning portion 1231 is brought into contact with an upstream-side end edge in the conveying direction (rear end edge in the conveying direction) of the panel P1, and the panel P1 is moved in the Y-direction. The separation distance in the Y-direction between the contact portion 1232 and the contact unit 151 when the suctioning portion 1231 is stopped is substantially equal to the width of the panel P1 in the Y-direction. As a result, the panel P1 is positioned in the Y-direction with respect to the slide unit 123.

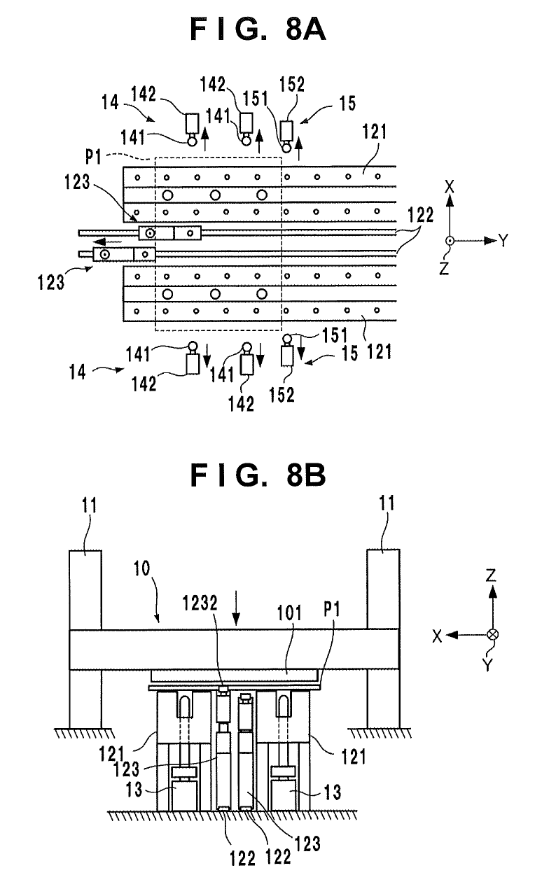

As described above, the attitude adjustment and the positioning of the panel P1 are completed. At this stage, the air is sucked from the suction hole 1231a of the suctioning portion 1231, and the panel P1 is suctioned/held by the suctioning portion 1231. As illustrated in FIG. 8A, each of the contact units 141 and 151 of the adjustment units 14 and 15 is returned to the retreat position.

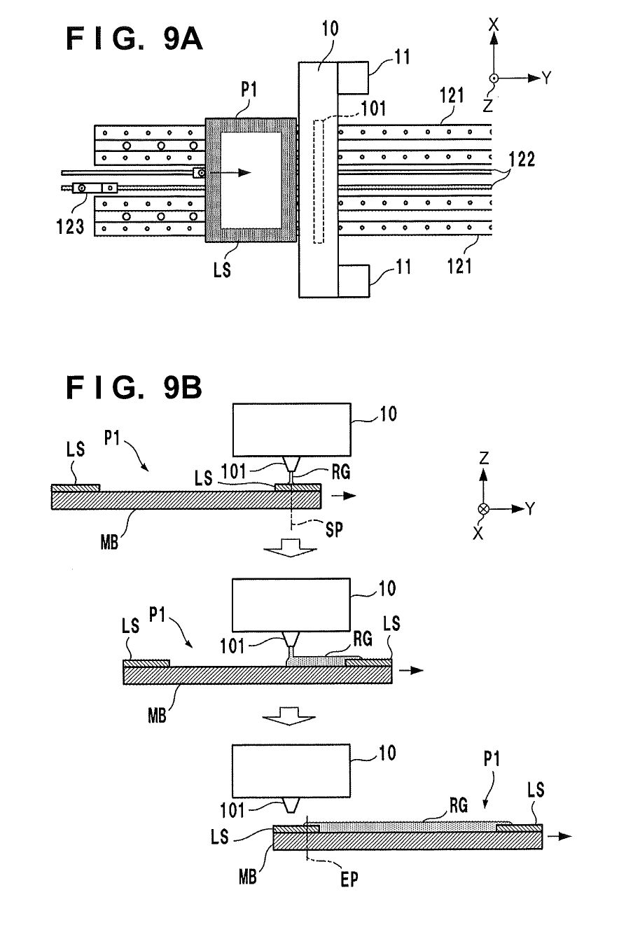

Next, the process proceeds to a process of applying the photocurable resin on the panel P1. As illustrated in FIG. 8B, the application head 10 is lowered to the lowered position. Next, as illustrated in FIG. 9A, the slide unit 123 suctioning the panel P1 is made to run toward the downstream side in the conveying direction, and the panel P1 is moved to below the application head 10.

As illustrated in FIG. 9B, the panel P1 is moved so that the panel P1 is faced with the nozzle 101 of the application head 10 and passes by it. As a result, the application head 10 is moved in the Y-directions relatively on the surface of the panel P1. During this moving process, as illustrated in FIG. 9B, the nozzle 101 discharges the photocurable resin RG (simply referred to as resin RG in some cases) and thus, a liquid film of the resin RG is applied on the surface of the panel P1. A discharge start position SP and a discharge end position EP of the resin RG on the panel P1 are set in accordance with an area of the panel P2 to be bonded. These positions and a width of a curtain of the resin RG discharged from the nozzle 101 are set so that the excessive resin RG does not protrude to the periphery of the panel P2 when the panel P1 and the panel P2 are bonded together.

Here, a difference in a surface level on the panel P1 by a thickness of the light shielding layer LS is generated at a boundary between a portion where the light shielding layer LS is formed and a portion where it is not formed. Due to the difference in a surface level, a difference in a surface level can also be generated on the liquid film surface of the resin RG on the panel P1, which is not preferable. Thus, a film thickness of the resin RG on the panel P1 is controlled so that the difference in a surface level is not generated.

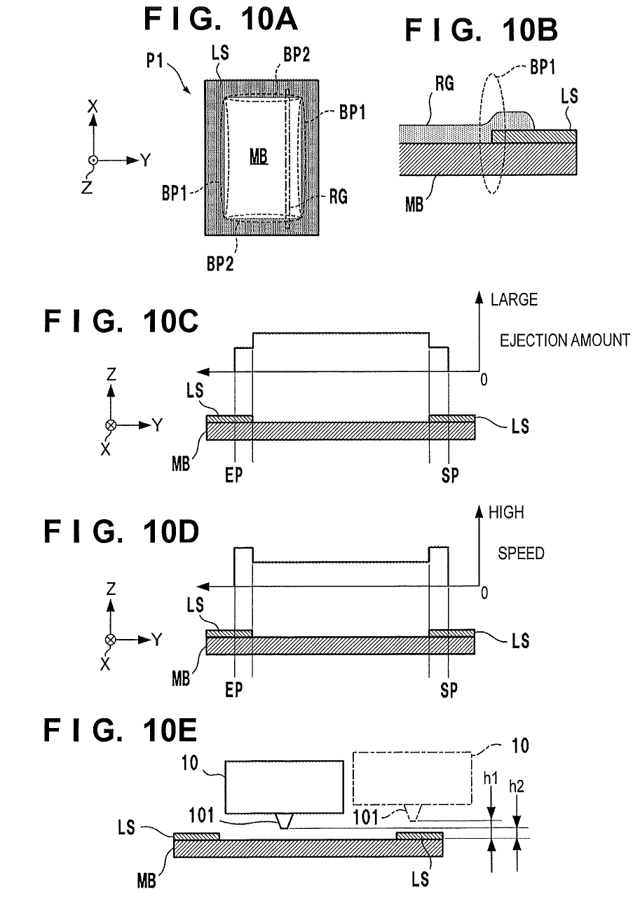

The difference in a surface level on the light shielding layer LS can be roughly divided into two types as illustrated in FIG. 10A depending on its portion. Since the light shielding layer LS is formed along each side of the panel P1, it forms a rectangular frame shape. A difference in a surface level BP1 is a portion extending in the X-direction, and a difference in a surface level BP2 is a portion extending in the Y-direction. At the difference in a surface level BP2, generation of the difference in a surface level on the resin RG can be suppressed by viscosity adjustment of the resin RG. The reason is as follows.

The curtain of the resin RG discharged from the nozzle 101 extends in the X-direction as illustrated in FIG. 10A. At the difference in a surface level BP2, an application area of the light shielding layer LS to the curtain of the resin RG is extremely small. Therefore, it is possible to suppress generation of the difference in a surface level by fluidity of the resin RG between the portion where the light shielding layer LS is not formed and the light shielding layer LS.

Moreover, at the difference in a surface level BP2, generation of the difference in a surface level on the resin RG can be also suppressed by adjusting a shape, a thickness and the like of a shim to be sandwiched in the application head 10.

On the other hand, at the difference in a surface level BP1, when the difference in a surface level BP1 is passed by, a ratio of the application area of the light shielding layer LS to the curtain of the resin RG and the application area of the portion where the light shielding layer LS is not formed become fifth-fifty. Thus, it is difficult to suppress generation of the difference in a surface level only by the fluidity of the resin RG between the portion where the light shielding layer LS is not formed and the light shielding layer LS, and as illustrated in FIG. 10B, a difference in a surface level can be easily generated on the surface of the resin RG.

Thus, generation of a difference in a surface level is suppressed by changing the film thickness of the resin RG between before and after passing by the difference in a surface level BP1. As a basic idea, the film thickness is controlled so that the film thickness of the resin RG becomes relatively thicker between these light shielding layers LS and LS (portion where the body MB is exposed) than the film thickness of the resin RG on the light shielding layer LS formed along each side on the upstream side and the downstream side of the panel P1 in the conveying direction. In other words, the film thickness is controlled so that the film thickness of the resin RG becomes relatively thinner on the light shielding layer LS than that between the light shielding layers LS and LS.

FIGS. 100 to 10E illustrate control examples of the film thickness. FIG. 100 illustrates an example of control of the film thickness by the discharge amount of the resin RG. In the example in this figure, the discharge amount of the resin RG to the positions of the panel P1 and the nozzle 101 is exemplified. The discharge amount is reduced on each of the light shielding layers LS on a front side and a rear side of the panel P1 in the moving direction (Y-direction), while the discharge amount is increased on a space between the light shielding layers LS and LS. The film thickness can be made relatively thicker between these light shielding layers LS and LS than on the light shielding layer LS, and generation of a difference in a surface level on the resin RG can be suppressed.

FIG. 10D illustrates an example of control of the film thickness by relative moving speed of the application head 10 and the panel P1. In this embodiment, the application head 10 is fixed to the Y-direction and thus, the moving speed of the panel P1 is changed. In the example of this figure, the moving speed of the panel P1 to the positions of the panel P1 and the nozzle 101 is exemplified. When each of the light shielding layers LS on the front side and the rear side in the moving direction (Y-direction) of the panel P1 passes below the nozzle 101, the moving speed of the panel P1 is made faster, while the moving speed is made slower on the space between the light shielding layers LS and LS. The film thickness can be made relatively thicker on the space between these light shielding layers LS and LS than that on the light shielding layer LS, and generation of a difference in a surface level of the resin RG can be suppressed.

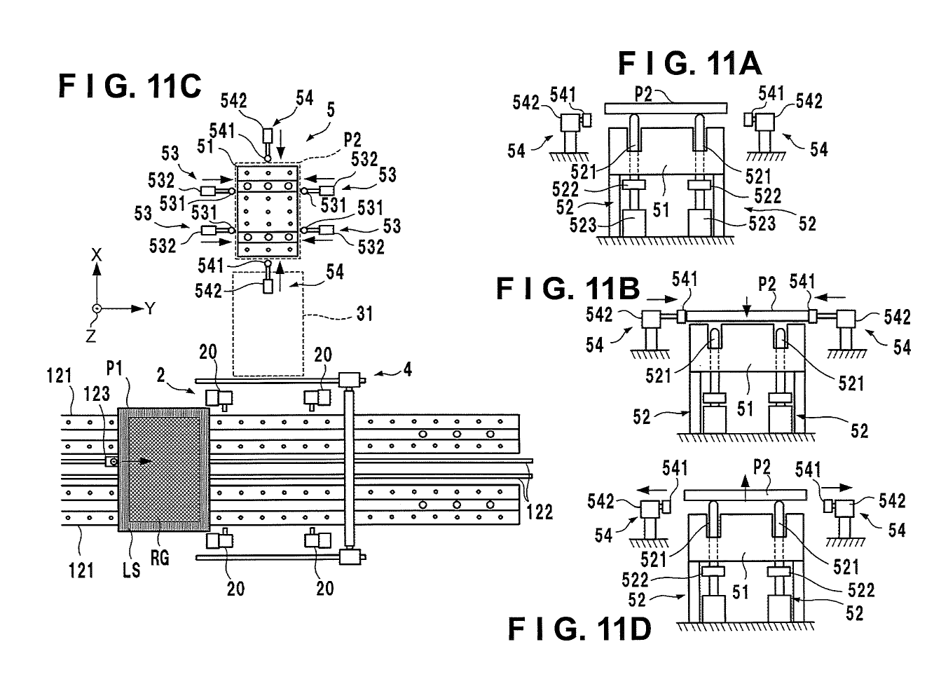

FIG. 10E illustrates an example of control of the film thickness by a height of the nozzle 101 from the surface of the panel P1. In this embodiment, the application head 10 can be elevated up/down by the moving mechanism 11, and thus, the height of the nozzle 101 from the surface of the panel P1 can be changed. In the example of this figure, the height of the nozzle 101 to the positions of the panel P1 and the nozzle 101 is exemplified. When each of the light shielding layers LS on the front side (indicated by a one-dot chain line in FIG. 11E) and on the rear side in the moving direction (Y-direction) of the panel P1 passes below the nozzle 101, the height is set to a height h1, and on the space between the light shielding layers LS and LS (indicated by a solid line in FIG. 11E), the height is set to a height h2 (<h1). The higher the height is, the more easily the resin RG can be spread over the panel P1, and the film thickness becomes thinner. Thus, the film thickness can be made relatively thicker between these light shielding layers LS and LS than that on the light shielding layer LS, and generation of a difference in a surface level of the resin RG can be suppressed.

The film thickness control examples in FIGS. 10C to 10E may be employed singularly or at least any two or more of them may be combined. An adjustable range of the film thickness can be widened by combination.

Next, the process proceeds to that of bonding the panel P1 and the panel P2 together. In parallel with the above-described processing to the panel P1, the panel P2 is carried into the carrying-in table 5 by the external device. The elevating unit 52 is in a state in which each pin 521 is located at the raised position, and the air is injected from the air hole 12 in the air floating table 51. Then, as illustrated in FIG. 11A in which an arrow 11A direction arrow view in FIG. 1 is illustrated, the panel P2 is carried in above the air floating table 51. The panel P2 is placed on the plurality of pins 521 in the horizontal attitude with a surface to be bonded to the panel P1 directed downward. The panel P2 is carried in and conveyed in this attitude, and the panel P1 is carried in and conveyed in the attitude with the surface to be bonded to the panel P2 directed upward, whereby “switching” for changing the attitude of upper and lower surfaces of the panel P1 and the panel P2 is made unnecessary when the both are to be bonded together.

As illustrated in FIG. 11B, each pin 521 is lowered to the lowered position by the elevating unit 52. As a result, the panel P2 is transferred from the plurality of pins 521 to the air floating table 51. At this time, the panel P2 is supported not in close contact with the upper surface of the air floating table 51 but in the floating state slightly floating from the upper surface.

Next, the attitude adjustment and positioning of the panel P2 are performed. As illustrated in FIGS. 11B and 11C, driving units 532 and 542 of each of the adjustment units 53 and 54 are driven, and contact units 531 and 541 are moved to the positioning positions. A separation distance in the Y-direction between the contact units 531 at the positioning positions is substantially equal to the width of the panel P2 in the Y-direction. Moreover, the separation distance in the X-direction between the contact units 541 at the positioning positions is substantially equal to the width of the panel P2 in the X-direction. Thus, if the attitude of the panel P2 is disturbed, the contact units 531 and 541 are brought into contact with a side edge of the panel P2, and the attitude and the position are adjusted. The panel P1 on which the resin RG is applied has been moved to the holding unit 2.

As described above, the attitude adjustment and the positioning of the panel P2 are completed. After that, as illustrated in FIG. 11D, the driving units 532 and 542 return the contact units 531 and 541 of the adjustment units 53 and 54 to the retreat positions, respectively, the elevating unit 52 raises each pin 521 to the raised position at the same time, and the panel P2 is lifted up.

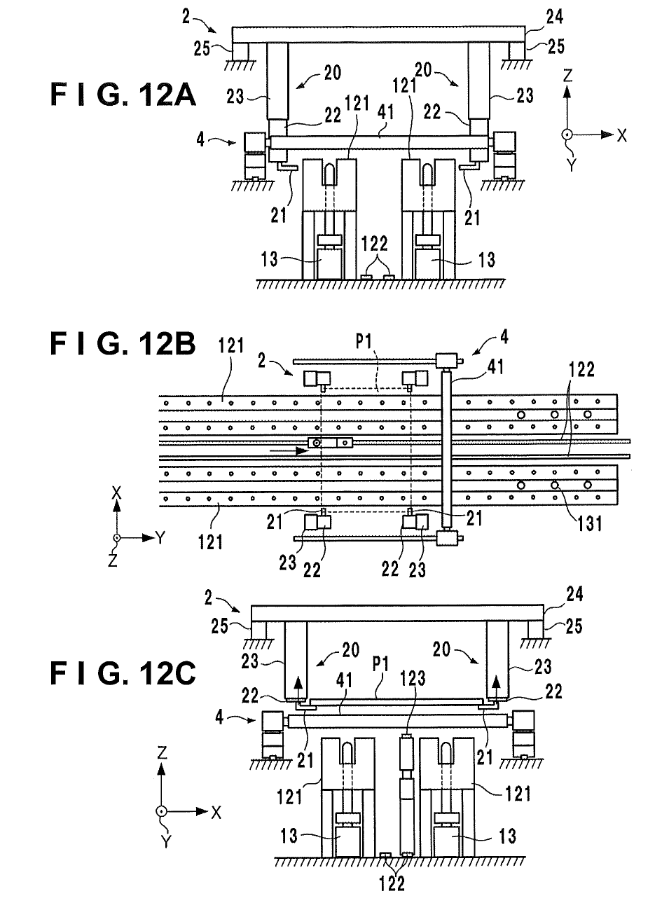

In parallel with the carrying-in of the panel P2, the panel p1 on which the resin RG is applied is held by the holding unit 2. As illustrated in FIG. 12A, each of the holding portions 21 of the holding unit 2 is located at a standby position below the upper surface of the air floating table 121. As illustrated in FIG. 12B, the panel P1 is moved to a position on each of the holding portions 21. Suctioning of the slide unit 123 by the suctioning portion 1231 is released, and as illustrated in FIG. 12C, each of the elevating mechanisms 23 is driven synchronously so as to synchronously raise each of the holding portions 21. As a result, the panel P1 is transferred from the slide unit 123 to the holding portion 21. Each of the holding portions 21 supports a portion where the resin RG is not applied on four corners of the panel P1 from below and is raised to a holding position higher than the roller 41.

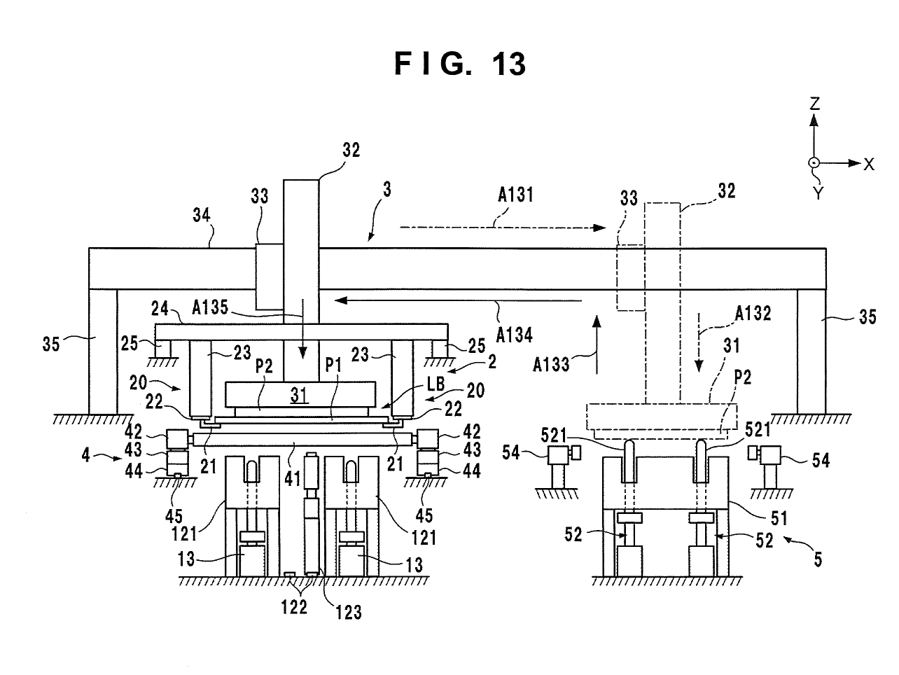

Next, the panel P2 having been carried into the carrying-in table 5 by the laminating unit 3 is conveyed to above the panel P1 held by the holding unit 2 and laminated. First, as indicated by a one-dot chain line and arrows A131 and A132 in FIG. 13, the suctioning unit 31 is moved onto the carrying-in table 5 and is lowered above the panel P2 so as to suction the panel P2.

Next, as indicated by a solid line and arrows A133 to A135 in FIG. 13, the suctioning unit 3 is raised and moved above the panel P1, the suctioning unit 31 is lowered so as to laminate the panel P2 on the panel P1. At this time, the panel P1 and the panel P2 are in a state of slight contact or slightly spaced away, and the panel P2 is still supported by the suctioning unit 31.

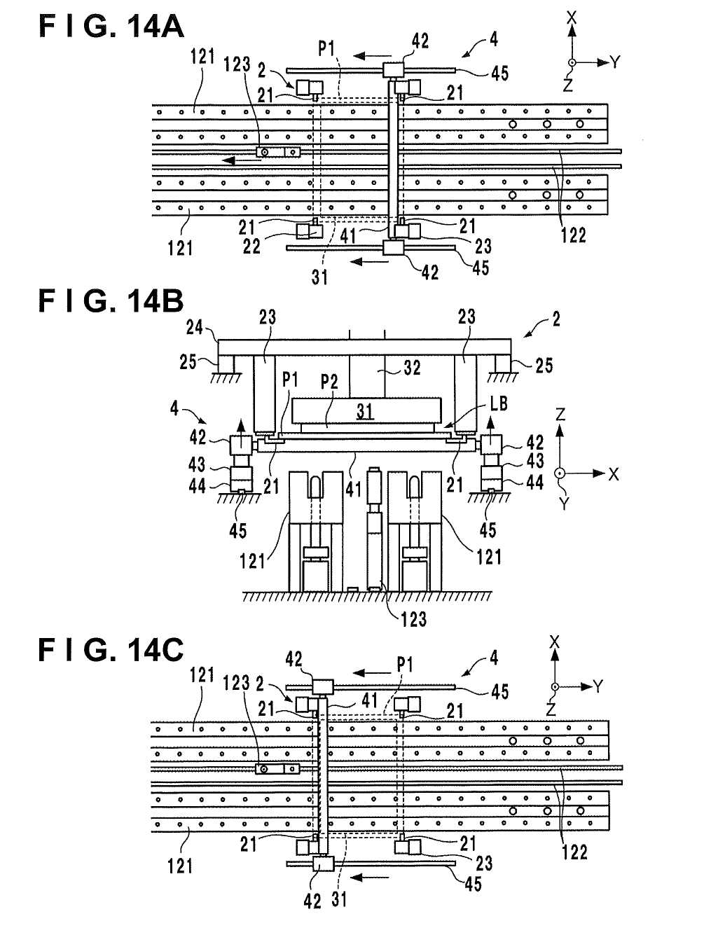

Next, a pressing force in a thickness direction is applied to the laminated body LB of the panel P1 and the panel P2. First, as illustrated in FIG. 14A, the roller 41 is moved to below the panel P1. The roller 41 is moved to the vicinity of the downstream-side end edge in the conveying direction of the panel P1 while avoiding a portion immediately below the holding portion 21 so that it does not interfere with the holding portion 21 later. The slide unit 123 is retreated to the upstream side.

Next, as illustrated in FIG. 14B, the roller 41 is raised by the elevating mechanism 43 and pressed upward (to the panel P2 side) in contact with the lower surface of the panel P1. A reaction force of the pressing is received by the laminating unit 3 through the suctioning unit 31. The laminated body LB enters a state sandwiched by the roller 41 and the suctioning unit 31. In this state, the roller 41 is moved in the Y-direction as illustrated in FIG. 14C and moved to the vicinity of the end edge on the upstream side in the conveying direction of the panel P1 within a range not interfering with the holding portion 21. Since the roller 41 is a free roller, it presses the lower surface of the panel P1 from the downstream side in the conveying direction to the upstream side while rotationally moving. As a result, the panel P1 and the panel P2 are brought into a pressed state while sandwiching the resin RG over the entire area of the laminated body LB, and the panel P1 and the panel P2 enter a state of temporary bonding by viscosity of the resin RG. In this state, the laminated body LB is substantially supported by the suctioning unit 31.

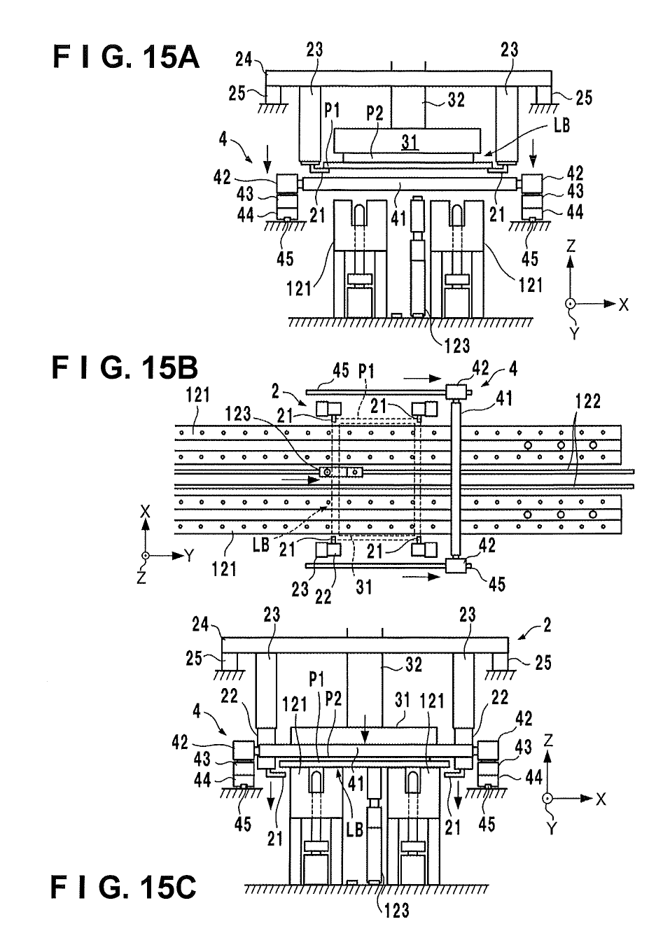

Next, the laminated body LB is transferred from the suctioning unit 31 to the slide unit 123. First, as illustrated in FIG. 15A, the roller 41 is lowered by the elevating mechanism 43. As illustrated in FIG. 15B, the roller 41 is moved in the Y-direction to an original position. Moreover, the slide unit 123 is moved to below the laminated body LB. As illustrated in FIG. 15C, each of the holding portions 21 of the holding unit 2 is lowered to the standby position, the suctioning unit 31 is lowered, and the laminated body LB is positioned on the air floating table 121. By resuming suctioning of the slide unit 123 by the suctioning portion 1231 and by releasing the suctioning of the suctioning unit 31, the laminated body LB is transferred from the suctioning unit 31 to the slide unit 123.

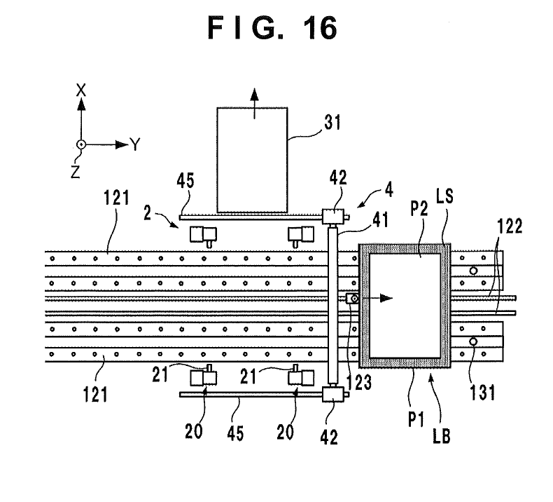

Next, the process proceeds to a process for carrying out the laminated body LB. As illustrated in FIG. 16, the slide unit 123 is moved, and the laminated body LB is moved to above the elevating unit 13 of the carrying-out area R3. The suctioning unit 31 is moved in the X-direction after being raised so as to perform subsequent processing. When the laminated body LB reaches a spot above the elevating unit 13 of the carrying-out area R3, each pin 131 is raised and brought into contact with the lower surface of the laminated body LB and then, suctioning of the laminated body LB by the suctioning portion 1231 of the slide unit 123 is released. As a result, the laminated body LB is transferred from the air floating table 121 to the pin 131 and enters a state capable of being delivered to a device of a supply destination.

As described above, in the manufacturing device A of this embodiment, in application of the resin RG to the panel P1, an influence of a difference in a surface level caused by presence of the light shielding layer LS can be suppressed, a liquid film with a flat surface can be formed, and the panel P1 and the panel P2 can be bonded favorably. As a result, the laminated body LB with a favorable quality can be manufactured efficiently. Moreover, operations from the application of the resin RG on the panel P1 to the bonding of the panel P1 and the panel P2 together can be continuously performed, and manufacturing efficiency of the laminated body LB can be improved.

In this embodiment, a cover panel and an image display panel are exemplified as the panel P1 and the panel P2, but the present invention can be also applied to panels other than them. The shapes of the panel P1 and the panel P2 are not limited to rectangles, either, but can handle various shapes. As a factor of the difference in a surface level of the resin RG, a difference in a surface level caused by presence of the light shielding layer LS is exemplified, but the present invention can be also applied to suppression of a difference in a surface level of the resin RG caused by a difference in a surface level other than this.

In this embodiment, when the resin is to be applied on the panel P1, it is configured that the panel P1 is moved in the Y-direction, but it may be configured such that the application head 10 is moved in the Y-direction. The height change of the nozzle 101 described by referring to FIG. 10E may be performed not by elevation of the application head 10 but by elevation of the panel P1.

In this embodiment, it is configured that the air floating table 121 and the slide unit 123 are combined as the moving mechanism 12 of the panel P1, but this is not limiting, and various moving mechanisms such as a belt conveyer, a roller conveyer and the like can be employed.

In this embodiment, it is configured that the laminating unit 3 suctions/holds the panel P2 by the suctioning unit 31, but the holding mechanism is not limited to that, and other holding mechanism including a mechanical holding mechanism such as a clamp mechanism and the like may be employed.

In this embodiment, the roller 41 is employed for pressing force of the laminated body LB, but a pressing force mechanism other than this can be also employed. Moreover, it is configured that the roller 41 is moved in the Y-direction in pressing force of the laminated body LB, but it may be so configured that the laminated body LB is moved in the Y-direction. Moreover, it is configured that the roller 41 is brought into contact with the lower surface of the panel P1, but to the contrary, it may be configured that the laminated body LB is supported from the lower side and pressed to the panel P1 side from the upper surface side of the panel P2.

In this embodiment, it is configured that the panel P1 is placed on the holding portion 21 as the holding mechanism of the panel P1 by the holding unit 2, but other holding mechanisms including a mechanical holding mechanism such as suctioning holding, a clamp mechanism and the like can be also employed.

### Second Embodiment

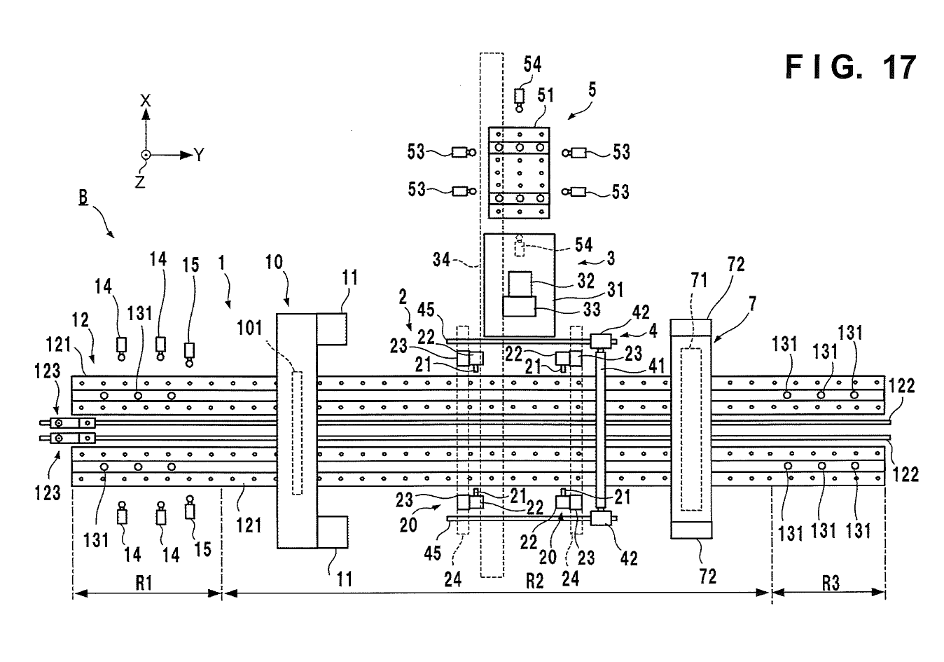

A configuration for promoting curing of the resin RG of the laminated body LB may be provided. FIG. 17 is a plan view of a manufacturing device B of this embodiment. The manufacturing device B is a device in which a curing promoting device 7 is added to the manufacturing device A, and the other configurations are the same as those of the manufacturing device A.

The curing promoting device 7 is arranged on the downstream side in the Y-direction from the application head 10 in the treatment area R2. The curing promoting device 7 is extended in the X-direction with both end portions thereof supported by columns 72 and is arranged horizontally above the upper surface of the air floating table 121.

The curing promoting device 7 is provided with a light source 71 extended in the X-direction. The light source 71 emits ultraviolet rays. When the laminated body LB moves below the curing promoting device 7, curing of the resin RG is promoted by executing a process of irradiating the laminated body LB with ultraviolet rays emitted by the light source 71, so that adhesion between the panel P1 and the panel P2 can be made firm.

### Third Embodiment

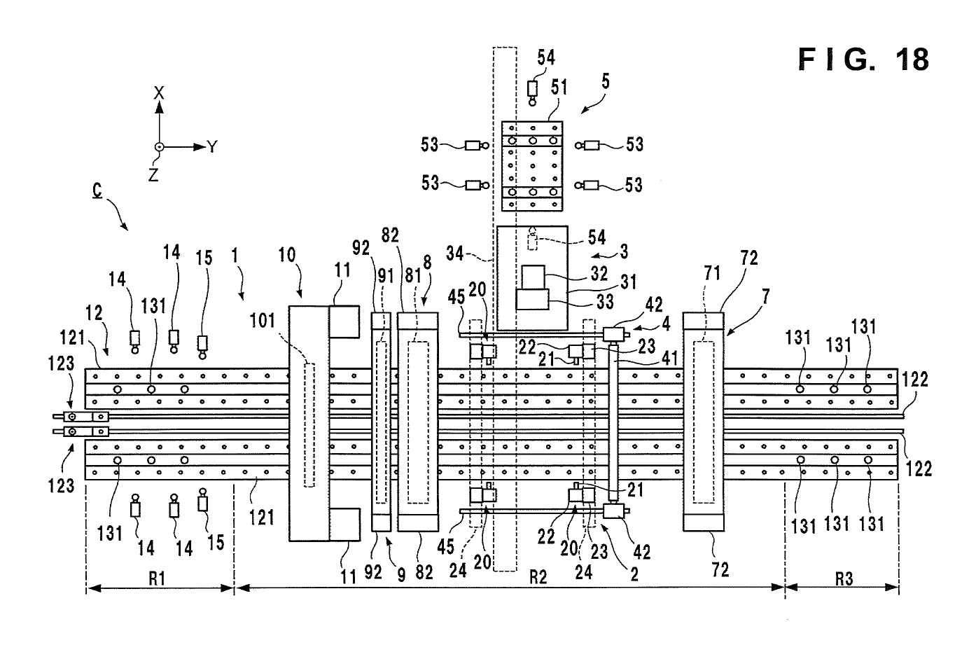

A configuration for promoting curing of the resin RG of the panel P1 may be provided. FIG. 18 is a plan view of a manufacturing device C of this embodiment. The manufacturing device C is a device in which a curing promoting device 8 and a shutter device 9 are added to the manufacturing device B, and the other configurations are the same as those of the manufacturing device B. In the manufacturing device C, a configuration in which the curing promoting device 7 is not provided can be also employed.

The curing promoting device 8 is arranged on the downstream side in the Y-direction from the application head 10 and on the upstream side from the holding unit 2 and the like in the treatment area R2. That is, it is located on the upstream side from a bonding position between the panel P1 and the panel P2.

A configuration of the curing promoting device 8 is the same as that of the curing promoting device 7. That is, the curing promoting device 8 is extended in the X-direction with both end portions thereof supported by columns 82 and is arranged horizontally above the upper surface of the air floating table 121. The curing promoting device 8 is provided with a light source 81 extended in the X-direction. The light source 81 emits ultraviolet rays. When the panel P1 moves below the curing promoting device 8, the resin RG can be semi-cured by executing a process of irradiating the panel P1 with ultraviolet rays emitted by the light source 81. As a result, when the panel P1 and the panel P2 are to be bonded together, mixing of air bubbles is prevented, positional shifts or the like of the both is prevented, and handling of the laminated body LB can be facilitated.

The shutter device 9 is arranged between the application head 10 and the curing promoting device 8. The shutter device 9 is extended in the X-direction with both end portions thereof supported by columns 92 and is arranged horizontally above the upper surface of the air floating table 121. The shutter device 9 is provided with a movable shutter 91 capable of shielding light between the application head 10 and the curing promoting device 8.

The shutter device 9 lowers the shutter 91 when the panel P1 passes below the shutter device 9 and shields light between the application head 10 and the curing promoting device 8. After that, the curing promoting device 8 is driven, and ultraviolet rays are emitted. The application head 10 is shielded form ultraviolet rays by presence of the shutter 91, and solidification of the resin RG adhering to the nozzle 101 can be suppressed. When the panel P1 passes through the curing promoting device 8 and driving of the light source 91 is stopped, the shutter 91 is raised.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefits of Japanese Patent Application No. 2014-123794, filed Jun. 16, 2014, which is hereby incorporated by reference herein in its entirety.

What is claimed is:

1. An applying method of applying a liquid photocurable resin on a surface of a panel, a difference in a surface level being formed on a peripheral portion of the surface of the panel,
said applying method including:
a moving step of moving either one of an application head or the panel so that the application head provided with a slit-type nozzle capable of discharging a photocurable resin relatively moves on the surface of the panel; and
an application step of discharging the photocurable resin from the nozzle onto the surface of the panel during said moving step, wherein
in said application step, a film thickness of the photocurable resin is controlled so that a difference in a surface level is not generated on a liquid film surface of the photocurable resin on the difference in a surface level on the panel.

2. The applying method according to claim 1, wherein
in said application step,
the film thickness is controlled by a discharging amount of the photocurable resin.

3. The applying method according to claim 1, wherein
in said application step,
the film thickness is controlled by a moving speed of the application head or the panel.

4. The applying method according to claim 1, wherein
in said application step,
the film thickness is controlled by a height of the nozzle from the surface of the panel.

5. The applying method according to claim 1, wherein
in said application step,
the film thickness is controlled by at least any two of
a discharging amount of the photocurable resin;
a moving speed of the application head or the panel; or
a height of the nozzle from the surface of the panel.

6. The applying method according to claim 1, wherein
the panel includes a light transmissive body and a light shielding layer formed on a peripheral, edge of the surface of the body,
the difference in a surface level on the panel is formed by a boundary between a portion where the light shielding layer is formed and a portion where the light shielding layer is not formed; and
the photocurable resin is a light transmissive resin having light transmitting property.

7. The applying method according to claim 6, wherein
the panel has a rectangular shape;
the nozzle is arranged in parallel with a pair of sides opposed to each other of the panel;
in said moving step,
one of the application head or the panel is moved in a direction orthogonal to the pair of sides;
in said applying step,
on the light shielding layer formed along the pair of sides, a film thickness of the photocurable resin is controlled so as to become relatively thinner; and
between the light shielding layers formed along the pair of sides, the film thickness of the photocurable resin is controlled so as to become relatively thicker.

8. An applying device for applying a liquid photocurable resin on a surface of a panel, comprising:
an application head provided with a slit-type nozzle capable of discharging the photocurable resin;
a moving mechanism configured to move at least either one of said application head or the panel so that the application head relatively moves on the surface of the panel; and
a control unit configured to control said application head and said moving mechanism, wherein
a difference in a surface level is formed on a peripheral portion of the surface of the panel; and
said control unit executes:
movement control for moving at least either one of said application head or the panel by said moving mechanism; and
application control for discharging the photocurable resin from the nozzle to the surface of the panel during the movement control; and
in the application control, on a difference in a surface level on the panel, a film thickness of the photocurable resin is controlled so that a difference in a surface level is not generated on a liquid film surface of the photocurable resin.

9. The applying device according to claim 8, wherein
in the application control,
the film thickness is controlled by a discharging amount of the photocurable resin.

10. The applying device according to claim 8, wherein
in the application control,
the film thickness is controlled by a moving speed of said application head or the panel.

11. The applying device according to claim 8, wherein
in the application control,
the film thickness is controlled by a height of the nozzle from the surface of the panel.

12. The applying device according to claim 8, wherein
in the application control,
the film thickness is controlled by at least any two of
an discharging amount of the photocurable resin;
a moving speed of said application head or the panel; or
a height of the nozzle from the surface of the panel.

13. A manufacturing method of a laminated body provided with a first panel and a second panel, comprising:
a step of applying a liquid photocurable resin on one surface of the first panel by an applying method according to claim 1;
a holding step of holding the first panel on which the photocurable resin is applied;
a laminating step of laminating the second panel on the one surface of the first panel; and
a pressing step of applying a pressing force to a laminated body of the first panel and the second panel in a thickness direction.

14. The manufacturing method according to claim 13, wherein
in said pressing step,
a roller is brought into contact with either one of the first panel or the second panel, and the laminated body is pressed in a thickness direction by moving either one of the laminated body or the roller.

15. The manufacturing method according to claim 13, further comprising:
a step of curing the photocurable resin by irradiating the laminated body with ultraviolet rays.

16. The manufacturing method according to claim 13, wherein
the first panel is a cover panel having light transmitting property;
the second panel is an image display panel;
the laminated body is an image display device;
in said holding step, said cover panel on which the photocurable resin is applied on a surface is held in an attitude with the surface directed upward;
in said laminating step, the image display panel is held by a suctioning unit configured to suck an upper side thereof in an attitude with a surface to which the cover panel is to be bonded directed downward and the image display panel is laminated on said cover panel; and
in said pressing step, the cover panel is brought into contact with the image display panel by a free roller from below and the image display device is pressed in a thickness direction by moving the free roller.

17. A manufacturing device of a laminated body provided with a first panel and a second panel, comprising:
an applying device according to claim 8;
a holding unit configured to hold the first panel on one surface of which a photocurable resin is applied by said applying device;
a laminating unit configured to laminate the second panel on the one surface of the first panel; and
a pressing unit configured to press a laminated body of the first panel and the second panel in a thickness direction.
